(19) United States
(12) Patent Application Publication
(10) Pub. No.: US 2007/0267271 A1
(43) Pub. Date: Nov. 22, 2007

(54) Conveyor Roller Assembly

(75) Inventor: Stephen Mark Brown, Victoria (AU)

Correspondence Address: WILLIAM J. SAPONE;COLEMAN SUDOL SAPONE P.C., 714 COLORADO AVENUE, BRIDGE PORT, CT, 06605, US

(73) Assignee: Roller Track Australia Pty Ltd., Bayswater (AU)

(21) Appl. No.: 10/561,076

(22) PCT Filed: Jun. 16, 2004
(86) PCT No.: PCT/AU04/00789

§ 371 Date: Mar. 1, 2007

(30) Foreign Application Priority Data
Jun. 17, 2003 (AU) 2003903108

(51) Int. Cl. B65G 1/08

(52) U.S. Cl. 193/37; 193/35 A

(57) ABSTRACT

A roller assembly 10 for use in live carton storage. The assembly 10 includes a roller support 12. The roller support 12 includes a base portion 14 and two wall portions 16, 18. The two wall portions 16, 18 are connected to and upstanding from the base portion 14. The roller assembly 10 includes at least one roller 32 rotatable about a roller axle 30, with the axle 30 of each roller 32 extending outwardly beyond the longitudinal ends 34 of the roller. Each wall portion 16, 18 of the roller support 12 includes a slot 24 for receiving a respective end of the axle 30 of each roller 32 for rotatably supporting the roller 32 there between. The roller assembly 10 also includes a means 34 for retaining the ends of each roller 30 axle in the respective receiving slots 24.

### TECHNICAL FIELD

The present invention relates generally to a roller assembly, and more particularly to an assembly for conveying containers, cartons, boxes, trays, receptacles and the like. The invention has been developed especially, but not exclusively, as an assembly for use in live carton storage and is herein described in that context. However, it is to be appreciated that the invention has broader application and is not limited to that particular use.

### BACKGROUND

Live carton storage refers to the arrangement whereby a number of product lines are each housed in separate containers, cartons, boxes, trays, receptacles or the like on one or more shelves, racks or other suitable structures. Shelves, racks and other structures suitable for use in live carton storage are hereinafter collectively referred to as “shelves”.

Hereafter, containers, cartons, boxes, trays, receptacles and the like used in live carton storage will be collectively referred to as “containers”.

One side of the shelves used in live carton storage, including the area immediately surrounding that shelf side, defines a picking area. An individual in the picking area can select desired items from the range of items provided in the various product lines, each provided in a separate container and presented on the shelves to the picking area.

As an item is selected and removed, the number of items available to the picking area from that product line diminishes. Continued removal of items from that product line results in emptying of the container holding those items, such that replenishment of that product line becomes necessary. Replenishment of a product line is possible via the replenishment area provided on the opposite side of the shelves to the picking area. The replenished items in another container are moved though the shelf arrangement from the replenishment area to the picking area, as required, so as to be available for individual picking.

Generally, the shelves are able to support several containers of a particular item, with containers holding a particular item type being provided on the shelves one behind the other, in rows extending between the replenishment area and the picking area. These rows are generally referred to in the industry as “lanes”. When the container at the picking area is emptied of items it is removed and each of the containers in the lane behind the emptied container are moved forward, such that access to the next (full) container in the lane is provided at the picking area.

Rollers are generally installed on or in place of shelve surfaces to facilitate ease of container movement across the structure from the replenishment area to the picking area. A number of individual rollers, generally configured in two (or possibly more) parallel rows extend between the replenishment area and the picking area, over which the containers are transferred. The rows of rollers are generally inclined downwardly from the replenishment area to the picking area, such that containers move by gravity across the rollers from the replenishment area to the picking area with minimal manual effort required.

Various configurations and designs of roller assemblies are currently available for use in live carton storage. Several existing roller assembly designs undesirably incorporate a relatively large number of separate parts, which results in a higher than desired production cost and assembly time.

Undesirably, some existing roller assembly designs are potentially subject to failure when subjected to heavy loads.

Moreover, existing roller assembly designs are difficult to repair, since individual damaged components cannot easily be replaced. Thus, damaged roller assembly components often result in entire roller assemblies needing to be replaced.

It would therefore be desirable to provide a simplified roller assembly when compared to existing roller assemblies, and which is more cost effective to manufacture and less time consuming to assemble.

It would also be desirable to provide a roller assembly that is less likely to fail when subjected to heavy loads.

Moreover, it would be desirable to be able to replace individual roller assembly components should the need arise.

The above discussion of the background to the invention is included to explain the context of the invention. This is not to be taken as an admission that any of the material referred to was published, known or part of the common general knowledge in Australia as at the filing date of the application.

### SUMMARY OF THE INVENTION

In a first broad aspect of the present invention, there is provided a roller assembly for use in live carton storage. The assembly includes a roller support. The roller support includes a base portion and two wall portions. The two wall portions are connected to and upstanding from the base portion. The roller assembly includes at least one roller rotatable about a roller axle, with the axle of each roller extending outwardly beyond the longitudinal ends of the roller. Each wall portion of the roller support includes a slot for receiving a respective end of the axle of each roller for rotatably supporting the roller there between. The roller assembly also includes a means for retaining the ends of each roller axle in the respective receiving slots.

In one form, the base portion and upstanding wall portions of the roller assembly define a longitudinally extending channel having a generally U-shape. The base portion and wall portions may be integrally formed.

In another form, the base portion and wall portions define a pair of longitudinally extending and generally L-shaped members. It is envisaged that the L-shaped members would be orientated parallel to one another, with the wall portions substantially upstanding from the respective base portions. The L-shaped members may be spaced apart any desired and/or practical distance for receiving the at least one roller between the wall portions.

The roller assembly may include a plurality of rollers, with each roller orientated generally transversely relative to the longitudinally extending base and wall portions.

The generally transversely orientated rollers may be spaced longitudinally along the wall portions of the roller support. Further, the rollers may be spaced equidistantly along the roller assembly, thereby potentially distributing the load carried by the assembly as evenly as possible between each of the rollers.

In one form, the axle ends of each roller are receivable in respective pairs of slots provided in the upstanding wall portions, with each slot pair being longitudinally spaced along the wall portions.

The slots may adopt any practical shape and form.

Each roller may be rotatable about a respective roller axle. Alternatively, it may be desirable for two or more rollers to share a common roller axle.

A roller retainer may be provided to retain each of the rollers in its desired position relative to the wall portions. The retainer may include two parallel and longitudinally extending axle abutment surfaces, which are configured to locate axially slightly beyond each end of the axle rollers when fitted in the slots provided in the wall portions. In this way, axial displacement of the roller axles relative to the roller support is limited to displacement between the axle abutment surfaces.

The axle abutment surfaces may form part of a frame that is connectable to the wall portions of the roller support.

The axles may be fixed to the rollers, in which case axial displacement of the rollers and the axles may be limited by the roller ends abutting the inside surfaces of the wall portions.

In a second broad aspect of the present invention, there is provided a motion control device for a roller assembly. The motion control device is pivotally connectable to a roller support of a roller assembly. The device includes at least one contact surface for impeding the motion of an object travelling over the rollers of the roller assembly.

The motion control device according to the present invention is particularly useful for roller assemblies used in live carton storage.

The motion control device may preferably be connected to the roller assembly any one of a plurality of possible orientations, thereby providing the potential of being able to be used for more than one specific use.

The motion control device may be connected to the roller support such that a contact surface is orientated generally flush with the plane of the roller contact. In this configuration the motion control device may be used for locking a roller support end cap in position on the roller support.

Alternatively, a contact surface may be orientated substantially perpendicularly relative to the plane of the roller contact, in order for the motion control device to act as an end stop preventing further motion of containers across the rollers.

In a yet further configuration a contact surface may be orientated at an angle somewhere between parallel and perpendicular to the plane of the roller contact, in order to slow or otherwise arrest the movement of any containers passing across the rollers.

The motion control device may include more than one contact surface.

The motion control device may include a pivot pin or other pivoting means. Alternatively, the device may include means for connecting a pivot pin other pivoting means.

More than one aspect of the aspect of the present invention has been described above in terms of a roller assembly and a motion control device. It is to be appreciated that these aspects can be considered separately or in combination.

### BRIEF DESCRIPTION OF THE DRAWINGS

It will be convenient to hereinafter describe preferred embodiments of the invention with reference to the accompanying drawings. The particularity of the drawings is to be understood as not limiting the preceding broad description of the invention.

In the drawings:

FIG. 1 illustrates in a cross-sectional side view first embodiments of the roller assembly and motion control device according to the present invention;

FIG. 2 illustrates in a cross-sectional side view the motion control device of FIG. 1 in another orientation relative to the roller assembly of FIG. 1;

FIG. 3 illustrates in a cross-sectional side view the motion control device of FIG. 1 in yet another orientation relative to the roller assembly of FIG. 1;

FIG. 4 illustrates in a cross-sectional side view the motion control device of FIG. 1 in a further orientation relative to the roller assembly of FIG. 1;

FIG. 5 illustrates in a cross-sectional side view the motion control device of FIG. 1 in a yet further orientation relative to the roller assembly of FIG. 1;

FIG. 6 illustrates in a cross-sectional side view the motion control device of FIG. 1 in another orientation relative to the roller assembly of FIG. 1;

FIG. 7 illustrates in a cross-sectional side view the motion control device of FIG. 1 in another orientation relative to the roller assembly of FIG. 1;

FIG. 8 is a perspective view of the motion control device of FIG. 1;

FIG. 9 is another perspective view of the motion control device of FIG. 1;

FIG. 10 is a plan view of the frame of the assembly illustrated in FIG. 1;

FIG. 11 is a sectional plan view of the frame illustrated in FIG. 10;

FIG. 12 is a sectional side view of the frame of FIG. 11 through section AA;

FIG. 13 is a close-up of a portion of FIG. 12;

FIG. 14 is a side view of the frame of FIG. 10;

FIG. 15 is a sectional end view of the frame of FIG. 10;

FIG. 16 is an end view of the frame of FIG. 10;

FIG. 17 is a sectional end view of the roller support of the assembly of FIG. 1;

FIG. 18 is a side view of the roller support of FIG. 17;

FIGS. 19 to 21 are various sectional side views of a second embodiment of a motion control device according to the present invention;

FIG. 22 is an end view of the device illustrated in FIGS. 19 to 21;

FIG. 23 is a plan view of the device illustrated in FIGS. 19 to 21;

FIGS. 24 to 35 illustrate the roller assembly of FIG. 1 and the device of FIGS. 19 to 21 in various possible arrangements;

FIG. 36 is a plan view of an alternative embodiment of the frame of FIG. 1;

FIG. 37 is an end view of the frame of FIG. 36;

FIG. 38 is an end view of alternative embodiment of a roller support;

FIG. 39 is an end view of the frame of FIG. 37 connected to the roller support of FIG. 38;

FIG. 40 is an end view of a roller of FIG. 1 when connected to the roller support of FIG. 38;

FIG. 41 is an end view of a portion of yet another embodiment of a roller support;

FIG. 42 is an end view of a portion of yet another embodiment of a roller support;

FIG. 43 is a close-up of FIG. 42;

FIG. 44 is an end view of the roller support portions illustrated in FIGS. 41 to 43, together with a roller.

### DETAILED DESCRIPTION OF THE DRAWINGS

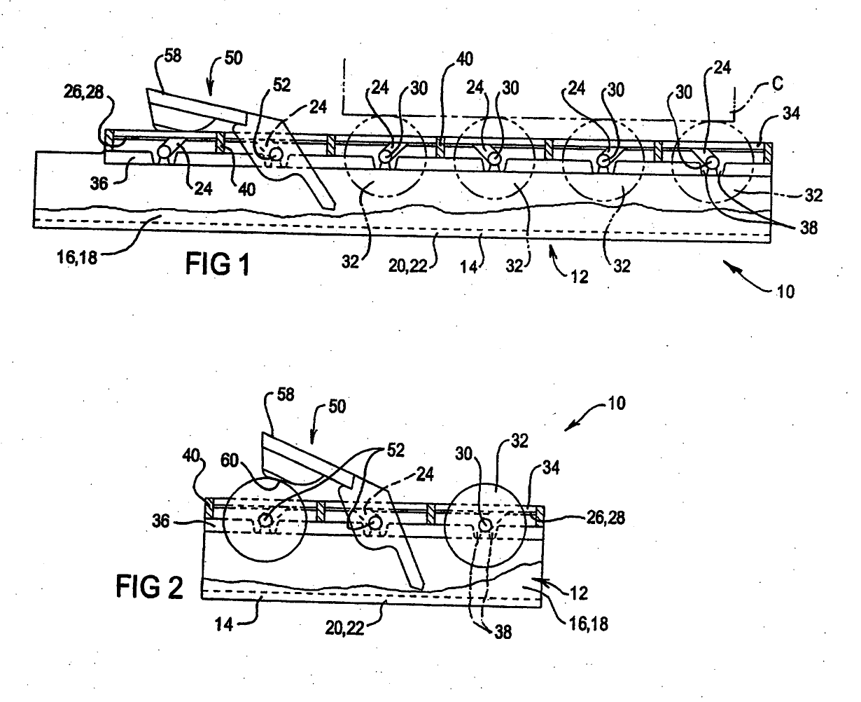

Referring to FIG. 1, there is illustrated a roller assembly 10 for use in live carton storage. A container C (not necessarily to scale) is illustrated in a dashed line format. The assembly 10 includes a longitudinally extending roller support 12. The roller support 12 is provided with a base portion 14 and upstanding wall portions 16,18. The wall portions 16,18 are connected along their lower longitudinally extending edges 20,22 to respective longitudinally extending edges of the base portion 14. The base portion 14 and wall portions 16,18 are integrally formed to define a longitudinally extending U-shaped channel. (Alternatively, two L-shaped channels may be provided.)

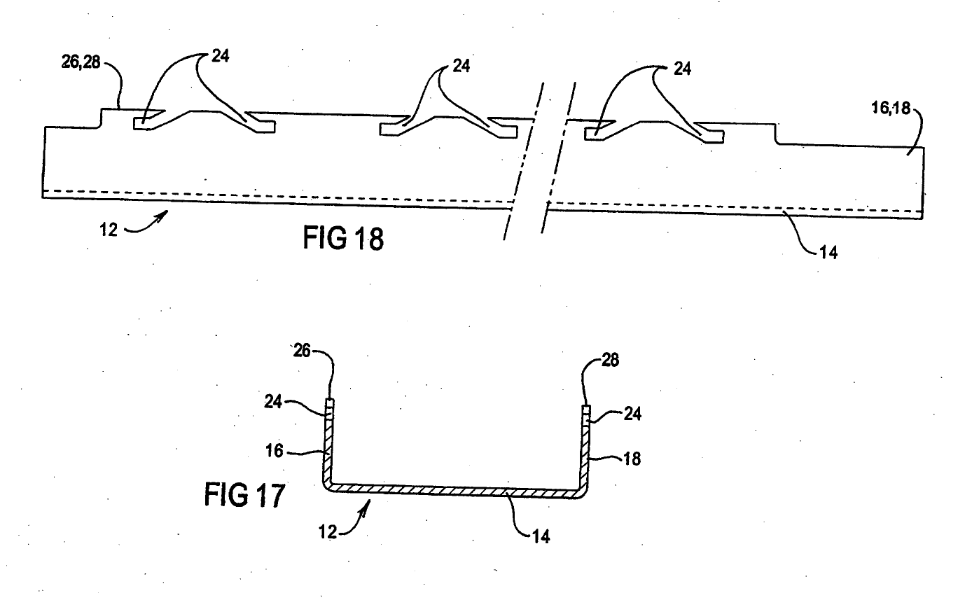

Pairs of slots 24 are provided along the length of the wall portions 16,18. Each slot extends downwardly from a respective upper edge 26,28 of the wall portions 16,18. The roller support 12 and the slots 24 are shown in greater detail in FIGS. 17 and 18.

Each of the pairs of slots 24 is provided for receiving an axle 30 of a respective roller 32. It is to be appreciated that the axle 30 of each roller 32 extends axially outwardly beyond the end faces 34 of the roller 32 to facilitate engagement of the axles 30 within the slots 24.

It is evident from FIGS. 1 and 18 that the slots 24 extend downwardly at an angle to vertical, and that adjacent slots 24 are angled in opposite directions about vertical.

The axles 30 can be removed from the rollers 32. However, it is to be appreciated that the rollers 32 may be connected to the axles 30 to facilitate ease of assembly and disassembly of the assembly 10.

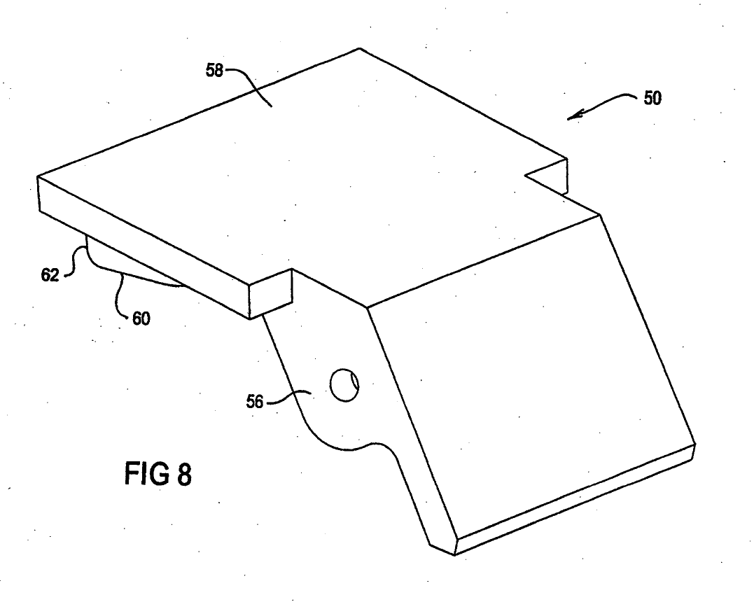

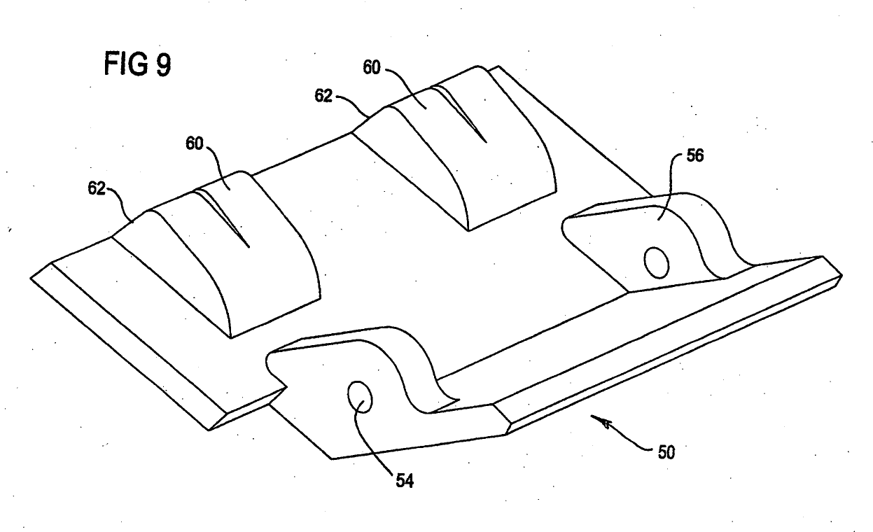

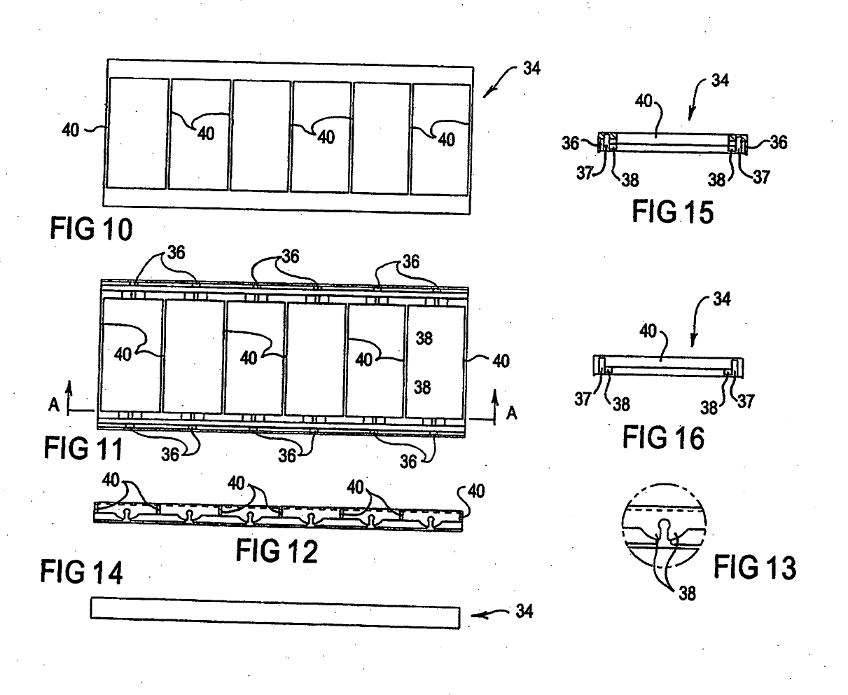

A means for retaining the ends of each axle 30 in the respective receiving slots 24 is provided in the form of a frame 34. The frame 34 is separately illustrated in FIGS. 10 to 16. The frame 34 includes longitudinally extending axle abutment surfaces 36. The surfaces 36 are located along either longitudinal side of the frame 34 and cover the ends of each of the axles 30, thereby limiting the axial displacement of the axles 30 to displacement between the axle abutment surfaces 36. The allowable axle displacement between the abutment surfaces 36 is minimal.

The frame 34 includes channels 37 for attaching the frame 34 over the upper edges 26,28 of the wall portions 16,18. The frame 34 includes axle locating lugs 38 (only some of which have been labelled in FIG. 11) for locating the frame 34 in the correct position relative to each of the axles 30 (and rollers 32).

The two longitudinally extending frame channels 37 are interconnected by way of spans 40.

The assembly 10 of FIG. 1 includes four rollers 32. The provision of four rollers 32 is for illustrative purposes only. It is to be appreciated that, generally speaking, the assembly 10 would include a greater number of rollers 32 in order for the assembly 10 to support a number of separate containers in lanes one behind the other.

The rollers 32 are manufactured from high density plastic, and are approximately 24 mm in diameter and 49 mm in axial length. Each of the axles 30 is manufactured from steel, and is approximately 3 mm in diameter and 77 mm in length. The roller support 12 is manufactured from galvanised steel, but could be manufactured from other materials such as plastic. The frame 34 is manufactured from high density plastic. The above reference to the various component materials and dimensions is provided for illustrative purposes only, and is in no way intended to limit the invention.

In use, two such assemblies 10 would be arranged in parallel and would be spaced apart a sufficient distance to support a container(s) thereon. The two assemblies 10 would be inclined at an angle to the horizontal of sufficient gradient for any containers located on top of the rollers to move at least substantially by gravity along the rollers. Movement of the container(s) would be from a replenishment area at one end (the upper end) of the assembly 10 to a picking area provided at the other end (the lower end) of the assembly 10.

Many existing assemblies include a frame configuration that is load bearing. This can undesirably lead to assembly failure under heavy loads. It is to be appreciated that the present invention has been designed such that the frame 34 is substantially non-load bearing. The frame 34 is provided primarily to retain the rollers 32 and axles 30 in position relative to the roller support 12.

Referring to FIGS. 8 and 9, there is illustrated a motion control device 50. The device 50 is pivotally connectable to a roller support 12 by a device axle 52, as illustrated in FIGS. 1 to 7. The axle 52 is received in pin receiving apertures 54,56. The ends of the device axle 52 are configured for receiving in a pair of the slots 24 in the same manner as the roller axles 30. Consequently, the device axles 52 and the roller axles 30 are substantially identical.

The device 50 is provided for, inter alia, slowing and/or stopping the motion of a container passing over the device 10. In this respect, the device 50 includes three separate contact surfaces 58,60,62. The surfaces 58,60,62 are provided for contact with a container passing across the assembly 10.

As illustrated in FIGS. 1 to 7, the device 50 can be mounted in any one of several orientations relative to the roller support 12.

In FIG. 1, the contact surface 58 is inclined to the plane of the roller contact surfaces 64. In this arrangement, containers passing from right to left over the rollers will be caused to slow down upon contacting the inclined surface 58.

In FIG. 2, the contact surface 58 is maintained at a steeper gradient when compared to the orientation illustrated in FIG. 1. The device 50 is maintained at this angle by surface 60 resting upon the roller 32 provided at the left-hand end of the assembly 10. It is to be appreciated that the orientation of the surface 58 in FIG. 2 would tend to slow a container passing from right to left across the rollers 32 more than the arrangement in FIG. 1. This is due to the fact that the surface 58 is provided at a greater angle relative to the plane 64 in the arrangement of FIG. 2 when compared with that of FIG. 1.

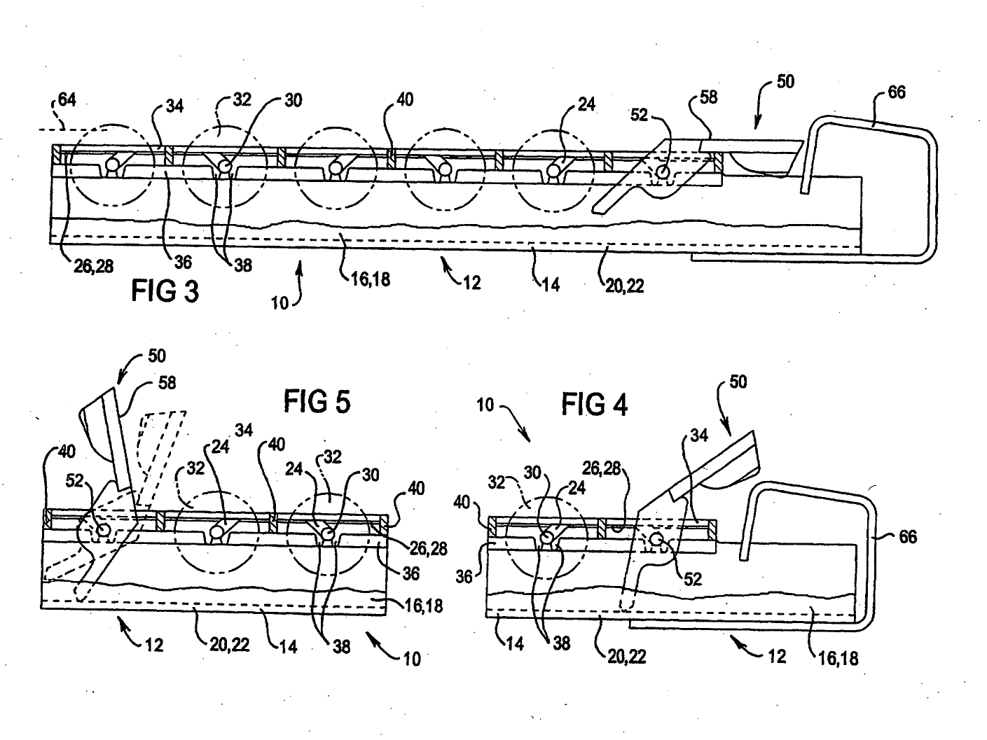

FIG. 3 illustrates the device 50 arranged such that the surface 58 is orientated is substantially the same plane as the roller contact surface 64.

FIG. 4 illustrates to device 50 being pivoted relative to the roller support 12.

Rather than being used to slow the movement of containers across the rollers 32, the device 50 can instead be used as an end stop to prevent the further movement of containers beyond a certain point. This is illustrated by the embodiments illustrated in FIGS. 5 to 7.

In FIG. 5, containers (not illustrated) moving from right to left across the rollers 32 impact with contact surface 58, thereby being prevented from further movement.

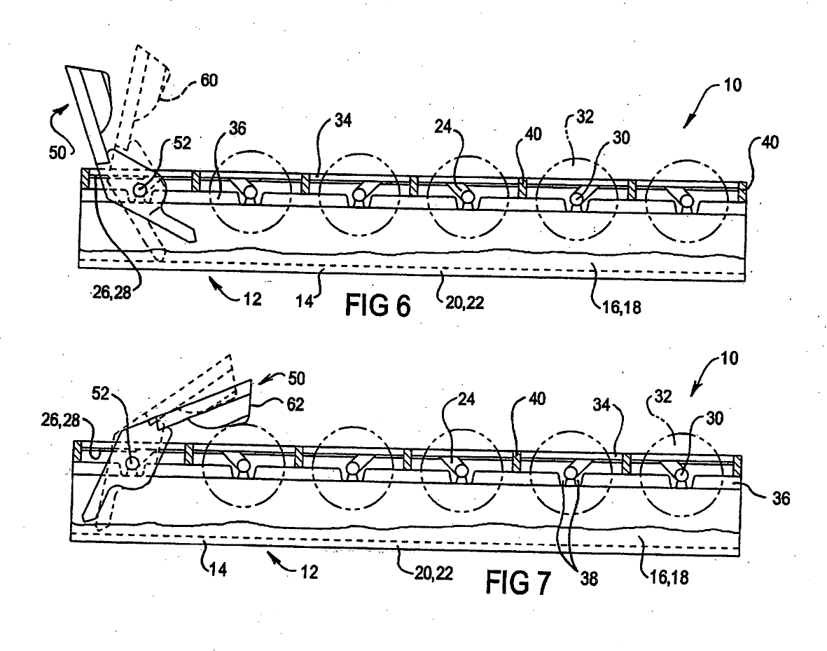

In FIG. 6 the containers moving from right to left across the rollers 32 impact with contact surface 60, thereby being prevented from further movement. In FIG. 5, the lower end of the device 50 rests on the upper surface of the base 14. In FIG. 6, the device 50 rests against the frame 34.

In FIG. 7, the containers moving from right to left across the rollers 32 impact with contact surface 62, thereby being prevented from further movement.

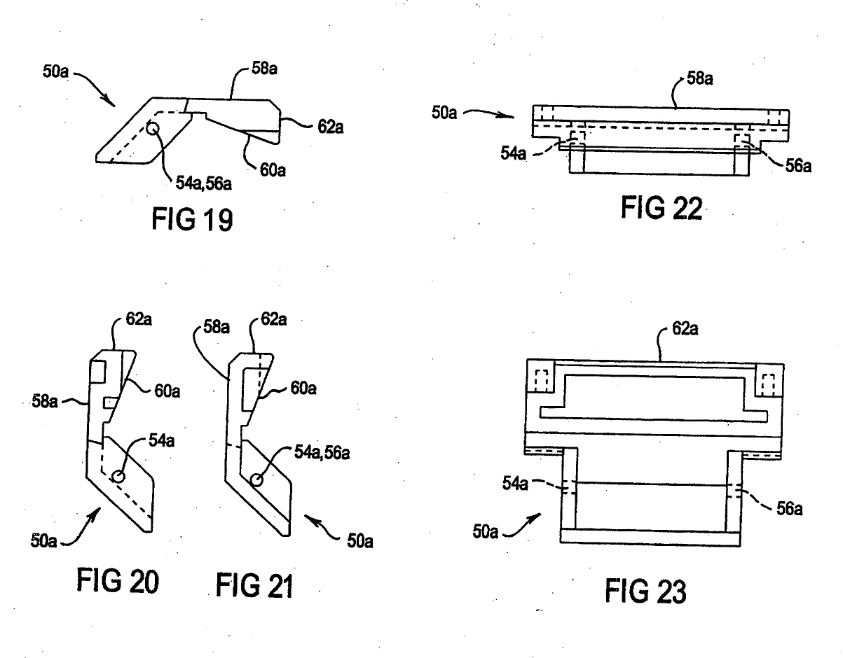

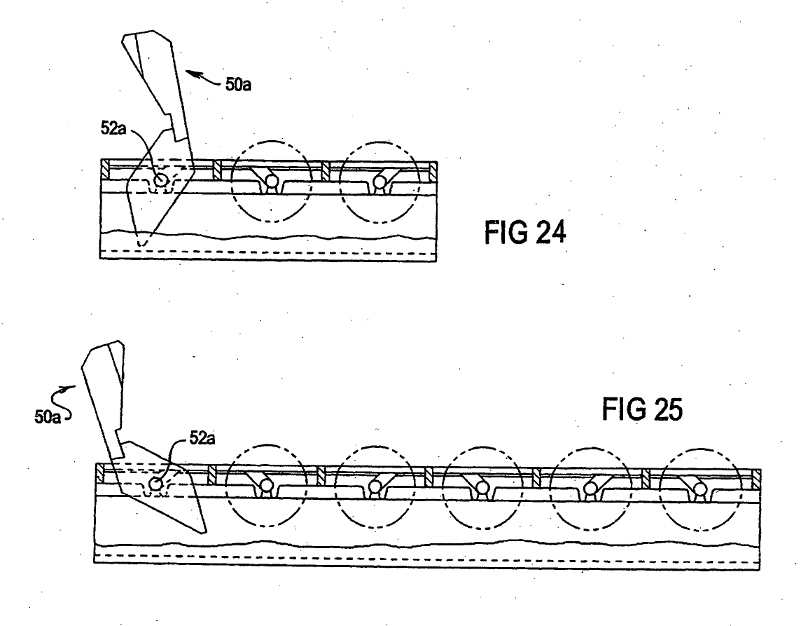

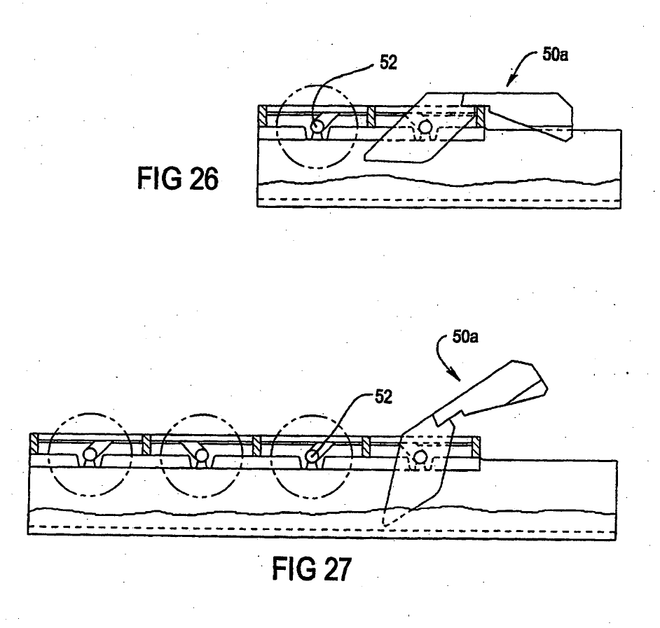

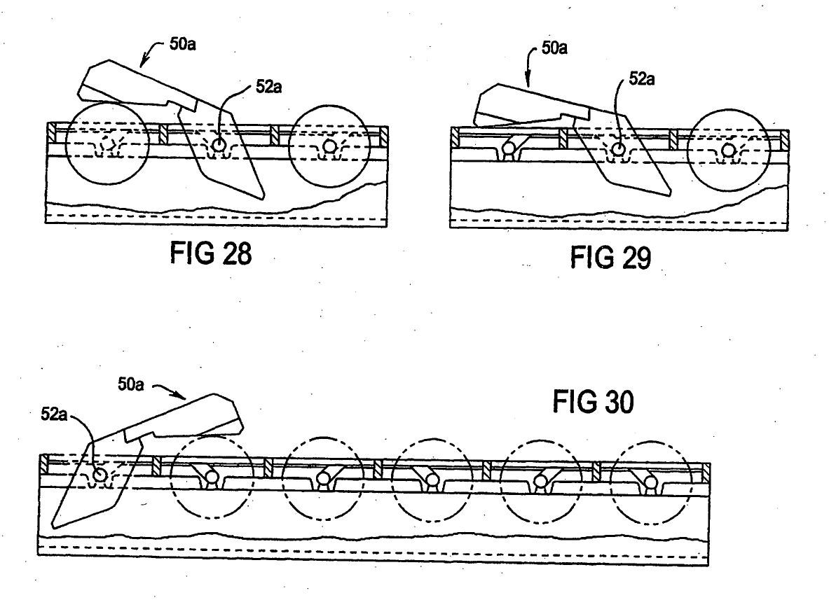

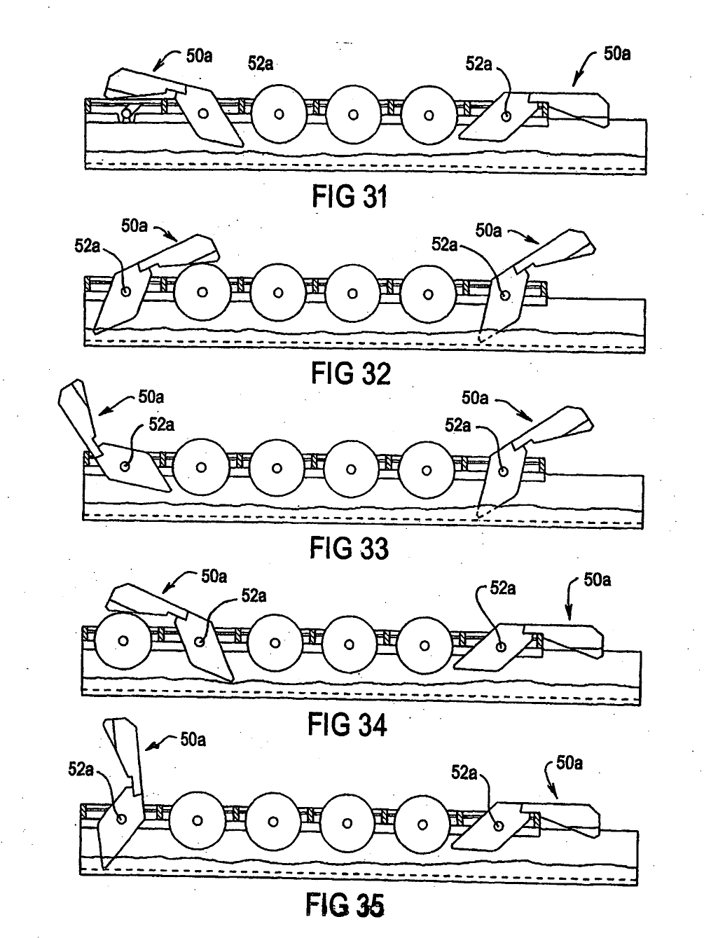

FIGS. 19 to 23 illustrate an alternative embodiment of a motion control device 50a according to the present invention. The device 50a is pivotally connectable to a roller support 12 by a device axle 52a, as illustrated in FIGS. 24 to 35. The device 50a includes pin receiving apertures 54a,56a, and three separate contact surfaces 58a,60a,62a. The device 50a is very similar in construction and function to the device 50 illustrated in FIGS. 1 to 9, and so the discussion of the device 50 is also applicable to the discussion of the device 50a.

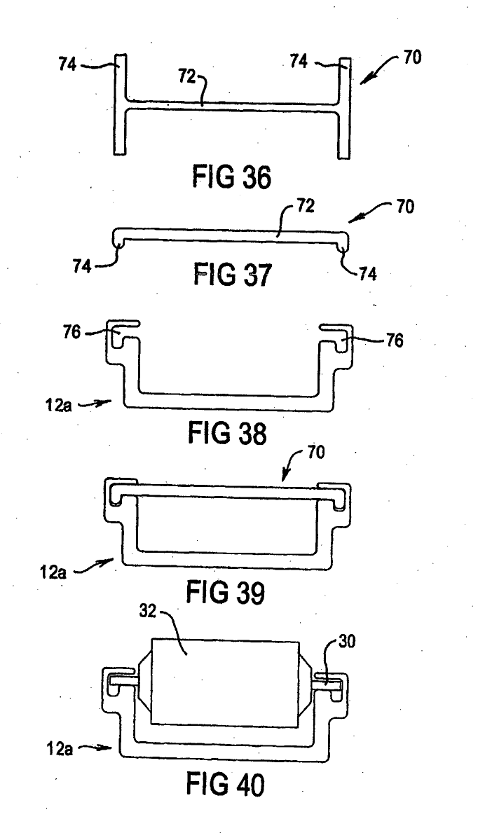

In FIGS. 36 and 37 a frame segment 70 is illustrated. Each assembly 10 would include a plurality of the segments 70 arranged to define a ladder-type structure akin to the frame 34 illustrated in FIGS. 1 to 7. The segment 70 includes a cross-span 72 integrally formed with two parallel lips 74 for engaging in the channels 76 provided in the roller support 12a illustrated in FIGS. 38 to 40. The channels 76 also accommodate axles 30 of rollers 32.

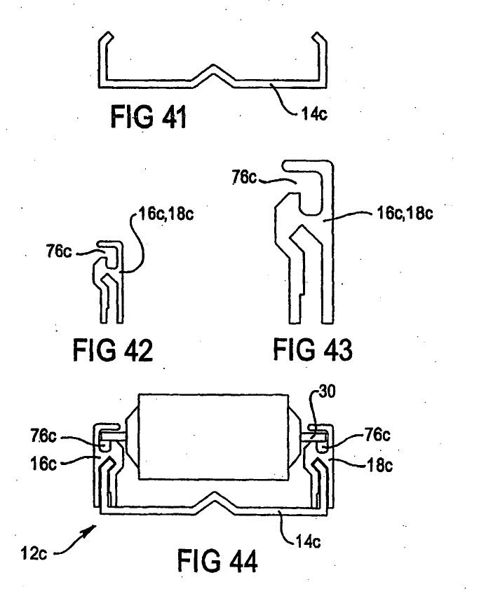

Referring to FIGS. 41 to 43, an alternative roller support 12c is illustrated. The support 12c includes a steel base 14c. The base 14c engages with two longitudinally extending, extruded plastic wall portions 16c,18c, as illustrated. Each of the roller axles 30 would be separated from adjacent roller axles 30 along the wall portions 16c,18c by a frame segment 70 (see FIGS. 36 and 37). Both the lips 74 of the frame segments 70, and the roller axles 30 are received in channels 76c.

The roller assembly 10 and motion control device 50 of the present invention are of simplified designs when compared to existing equivalents. Consequently they are more cost effective to manufacture, and easier to assemble and disassemble when compared to existing devices.

The frame 34 of the present invention is substantially non-load bearing, meaning that it is less likely to fail when compared to existing equivalents.

Also, the rollers 32 of the present invention are easily removed from the assembly 10 should maintenance of replacement be necessary.

Finally, the range of possible uses for the motion control device 50 is greater than the range of possible uses of existing equivalents.

Finally, it is to be understood that various alterations, modifications and/or additions may be introduced into the construction and arrangement of the parts previously described without departing from the spirit or ambit of this invention.

1-26. (canceled)

27. A roller assembly for use in live carton storage, the assembly comprising:
at least one roller rotatable about a roller axle, with the axle of each roller extending outwardly beyond the longitudinal ends of the roller;
a roller support comprising a base portion and two wall portions, the two wall portions being connected to and upstanding from the base portion, and each wall portion of the roller support comprising a slot for receiving a respective end of the axle of each roller for rotatably supporting the roller therebetween;
the axle ends of each roller being receivable in respective pairs of slots provided in the upstanding wall portions, with each slot pair being longitudinally spaced along the wall portions;
a means for retaining the ends of each roller axle in the respective receiving slots; and
a roller retainer for retaining each of the rollers in its desired position relative to the wall portions, the retainer comprising two generally parallel and longitudinally extending axle abutment surfaces, for locating axially slightly beyond each end of the axle rollers when fitted in the slots provided in the wall portions, the axle abutment surfaces forming part of a frame that is connectable to the wall portions of the roller support.

28. A roller assembly for use in live carton storage, the assembly comprising:
at least one roller rotatable about a roller axle, with the axle of each roller extending outwardly beyond the longitudinal ends of the roller;
a roller support comprising a base portion and two wall portions, the two wall portions being connected to and upstanding from the base portion, and each wall portion of the roller support comprising a slot for receiving a respective end of the axle of each roller for rotatably supporting the roller there between; and
a means for retaining the ends of each roller axle in the respective receiving slots.

29. A roller assembly according to claim 28, wherein the base portion and upstanding wall portions define a longitudinally extending channel having a generally U-shape.

30. A roller assembly according to claim 28, wherein the base portion and side portions define a pair of longitudinally extending and generally L-shaped members, which are orientated parallel to one another.

31. A roller assembly according to claims 28, comprising a plurality of rollers, with each roller orientated generally transversely relative to the longitudinally extending base and wall portions.

32. A roller assembly according to claim 31, wherein the generally transversely orientated rollers are spaced longitudinally along the wall portions of the roller support.

33. A roller assembly according to claim 32, wherein the rollers are spaced equidistantly along the roller support.

34. A roller assembly according to claims 31, wherein the axle ends of each roller are receivable in respective pairs of slots provided in the upstanding wall portions, with each slot pair being longitudinally spaced along the wall portions.

35. A roller assembly according to claims 28, wherein each roller is rotatable about a respective roller axle.

36. A roller assembly according to claim 34, wherein each slot pair extends downwardly from the upstanding edge of each wall portion at an inclined angle.

37. A roller assembly according to claim 36, wherein the inclined angle of each adjacent slot pair is generally equal and opposite.

38. A roller assembly according to claims 31, wherein two or more rollers share a common roller axle.

39. A roller assembly according to claims 28, comprising a roller retainer for retaining each of the rollers in its desired position relative to the wall portions.

40. A roller assembly according to claim 39, wherein the retainer comprises two parallel and longitudinally extending axle abutment surfaces, which are configured to locate axially slightly beyond each end of the axle rollers when fitted in the slots provided in the wall portions.

41. A roller assembly according to claim 40, wherein the axle abutment surfaces form part of a frame that is connectable to the wall portions of the roller support.

42. A roller assembly according to claim 40, wherein an axle is fixed to each roller, such that axial displacement of the rollers and axles within the assembly is limited by the roller ends abutting the inside surfaces of the wall portions.

43. A roller assembly according to claim 41, wherein the frame comprises: channels for attaching the frame over the upper edges of the wall portions; and axle locating lugs for locating the frame relative to each of the axles.

44. A roller assembly according to claims 28, comprising a motion control device, the motion control device having at least one object contact surface for impeding the motion of an object travelling over the at least one roller of the roller assembly, wherein the motion control device is pivotally connectable to a roller support of the assembly.

45. A roller assembly according to claim 44, wherein the motion control device is mountable to the roller assembly in any one of a plurality of possible orientations, thereby providing the potential of being able to be used for more than one specific use.

46. A roller assembly according to claim 44, wherein the motion control device is connectable to the roller support such that an object contact surface is orientated generally flush with a plane defined by the points of contact between an object and the rollers, for locking a roller support end cap in position on the roller support.

47. A roller assembly according to claim 44, wherein the motion control device is connectable to the roller support such that an object contact surface is orientated substantially perpendicularly relative to the plane defined by the points of contact between an object and the rollers, such that the motion control device acts as an end stop preventing further motion of containers across the at least one roller.

48. A roller assembly according to claim 44, wherein the motion control device is connectable to the roller support such that an object contact surface is orientated at an angle between parallel and perpendicular to the plane defined by the points of contact between an object and the rollers, in order to slow or otherwise arrest the movement of any containers passing across the at least one roller.

49. A motion control device for a roller assembly, wherein the motion control device is pivotally connectable to a roller support of a roller assembly, and comprises at least one contact surface for impeding the motion of an object travelling over the rollers of the roller assembly.

50. A motion control device according to claim 49, wherein device is mountable to a roller assembly in any one of a plurality of possible orientations, thereby providing the potential of being able to be used for more than one specific use.

51. A motion control device according to claim 49, wherein the device is connectable to a roller support such that a contact surface is orientated generally flush with a plane defined by the points of contact between an object and the rollers, for locking a roller support end cap in position on the roller support.

52. A motion control device according to claim 49, wherein the device is connectable to a roller support such that a contact surface is orientated substantially perpendicularly relative to a plane defined by the points of contact between an object and the rollers, for acting as an end stop preventing further motion of containers across the at least one roller.

53. A motion control surface according to claim 49, wherein the device is connectable to a roller support such that a contact surface is orientated at an angle between parallel and perpendicular with a plane defined by the points of contact between an object and the rollers, for slowing or otherwise arresting the movement of any containers passing across the at least one roller.
